(19) United States
(12) Patent Application Publication
(10) Pub. No.: US 2026/0364529 A1
(43) Pub. Date: Nov. 19, 2026

(54) CO2 SEQUESTER TRANSFORMER COOLING

(71) Applicant: Hitachi Energy Ltd, Zürich (CH)

(72) Inventor: Luiz Cheim, Raleigh, NC (US)

(21) Appl. No.: 19/133,508

(22) PCT Filed: Nov. 28, 2023
(86) PCT No.: PCT/EP2023/083278

§ 371 Date: May 28, 2025

Related U.S. Application Data
(60) Provisional application No. 63/428,646, filed on Nov. 29, 2022.
(60) Provisional application No. 63/471,442, filed on Jun. 6, 2023.

(30) Foreign Application Priority Data
Dec. 23, 2022 (EP) 22216556.5

(51) Int. Cl. B01D 53/62; B01D 53/04

(52) U.S. Cl. CPC B01D 53/62; B01D 53/0438; B01D 2257/504; B01D 2258/06

(57) ABSTRACT

A CO2 sequester and/or capture cooling system comprising a CO2 sequester and/or capture module configured to be coupled to a hot-insulating liquid heat transfer system of a transformer and/or at least one of an air inlet and an air outlet of a cooling fan of a transformer the CO2 sequester and/or capture module further configured to separate CO2 from the ambient air that is at least one of received into the air inlet of the cooling fan and exited out of the outlet of the cooling fan.

### CROSS REFERENCE TO RELATED APPLICATIONS

This application is a 35 U.S.C. § 371 national stage application of PCT International Application No. PCT/EP2023/083278 filed on Nov. 28, 2023, which in turn claims priority to U.S. Patent Application No. 63/471,442, filed on Jun. 6, 2023, which in turn claims priority to European Parent Application No. 22216556.5, filed Dec. 23, 2022, which in turn claims priority to U.S. Patent Application No. 63/428,646, filed on Nov. 29, 2022, the disclosures and content of which are incorporated by reference herein in their entireties.

### TECHNICAL FIELD

The embodiments described herein are generally directed to carbon dioxide (“CO2”) sequestering and/or capturing.

### BACKGROUND

Examples of commercial plants for capturing carbon dioxide directly from air include fans which push air through a filter system that collects CO2. When the filter is saturated, CO2 is separated at high temperatures, such as above 100 degrees Celsius, which can then be used for a variety of applications, such as growing vegetables, carbonating beverages, etc.

### SUMMARY

Aspects of the disclosure involve a CO2 sequester and/or capture cooling system comprising a CO2 sequester and/or capture module configured to be coupled to at least one of an air inlet and an air outlet of a cooling fan of a transformer, the CO2 sequester and/or capture module further configured to separate CO2 from the ambient air that is at least one of received into the air inlet of the cooling fan and exited out of the outlet of the cooling fan.

One or more implementations of the above aspects comprises one or more of the following: a housing having a housing air inlet, and a housing air outlet configured to be coupled to the air inlet of the cooling fan, wherein the CO2 sequester and/or capture module is disposed within the housing, and wherein the ambient air is received in the air inlet of the housing and CO2-reduced air from the CO2 sequester and/or capture module is delivered to the air inlet of the cooling fan via the housing air outlet; a housing having a housing air inlet configured to be coupled to the air outlet of the cooling fan, and a housing air outlet, wherein the CO2 sequester and/or capture module is disposed within the housing, and wherein the ambient air is delivered from the cooling fan through the air inlet of the housing and CO2-reduced air from the CO2 sequester and/or capture module is delivered from the housing via the housing air outlet; the ambient air delivered from the cooling fan to the CO2 sequester and/or capture module is transformer-heated ambient air and wherein the CO2 sequester and/or capture module is configured to be flushed of CO2 based at least in part on the transformer-heated ambient air; the cooling fan of the transformer is part of a compact cooler, in particular a compact oil air cooler, and the cooling fan is configured to extract air from the compact cooler, in particular the compact oil air cooler; the housing air inlet is configured to be coupled to the air outlet of the cooling fan via an upstream cooling element, and wherein the ambient air is delivered from the cooling fan past the cooling element and through the air inlet of the housing, and CO2-reduced air from the CO2 sequester and/or capture module is delivered from the housing via the housing air outlet; one or more heater units configured to heat the CO2 sequester and/or capture module and a temperature control system configured to control the one or more heater units to heat the CO2 sequester and/or capture module to a desired setpoint temperature, wherein CO2 is flushed from the CO2 sequester and/or capture module; the temperature control system is a control loop temperature control system; the control loop temperature control system includes a temperature sensor configured to sense a temperature at the CO2 sequester and/or capture module; the control loop temperature control system includes a controller configured to compare the sensed temperature at the CO2 sequester and/or capture module to the desired setpoint temperature to flush CO2 from the CO2 sequester and/or capture module to determine if the CO2 sequester and/or capture module requires further heating by the one or more heater units to the desired setpoint temperature to flush CO2 from the CO2 sequester and/or capture module; the control loop temperature control system includes a cooling element temperature sensor configured to sense a temperature related to a cooling element of the transformer, and the controller is configured to monitor the cooling element temperature sensor to determine if the CO2 sequester and/or capture module requires further heating by the one or more heater units to the desired setpoint temperature to flush CO2 from the CO2 sequester and/or capture module; the CO2 sequester and/or capture module is one of a membrane or solid material CO2 sequester and/or capture module; the CO2 sequester and/or capture module is a chemical CO2 sequester and/or capture module; and/or the CO2 sequester and/or capture module is a combined membrane and/or solid and/or chemical CO2 sequester and/or capture module.

Another aspect of the disclosure involves a method comprising receiving ambient air in a CO2 sequester and/or capture module configured to be coupled to at least one of an air inlet and an air outlet of a cooling fan of a transformer; and separating with the CO2 sequester and/or capture module CO2 from the ambient air that is at least one of received into the air inlet of the cooling fan and exited out of the outlet of the cooling fan of the transformer.

One or more implementations of the above aspect of the disclosure described immediately above comprises one or more of the following: receiving temperature of the CO2 sequester and/or capture module; comparing the received temperature of the CO2 sequester and/or capture module to a desired flushing setpoint temperature; controlling one or more heater units to raise the temperature of the CO2 sequester and/or capture module to the desired setpoint temperature to flush CO2 from the CO2 sequester and/or capture module; delivering to the CO2 sequester and/or capture module transformer-heated ambient air; optionally heating the delivered transformer-heated ambient air to the desired setpoint temperature to flush CO2 from the CO2 sequester and/or capture module; wherein the CO2 sequester and/or capture cooling system is adjacent to the transformer, and the method further comprising receiving power at the one or more heater units from the adjacent transformer; and/or optionally delivering to the CO2 capture module (170) heat from wasted energy hot insulating liquid (e.g., mineral oil, natural ester, synthetic ester, silicone fluid, LFH (less flammable hydrocarbons), bio-based hydrocarbons) of a transformer hot-insulating liquid heat transfer system.

An additional aspect of the disclosure involves a CO2 capture cooling system comprising a CO2 capture module configured to be coupled to a hot-insulating liquid heat transfer system of a transformer and at least one of an air inlet and an air outlet of a cooling fan of a transformer, the CO2 capture module further configured to separate CO2 from the ambient air that is at least one of received into the air inlet of the cooling fan and exited out of the outlet of the cooling fan.

One or more implementations of the above aspect of the disclosure described immediately above comprises one or more of the following: a CO2 capture module hot heat transfer liquid heat transfer system configured to be coupled to the transformer hot-insulating liquid heat transfer system, the CO2 capture module hot heat transfer liquid heat transfer system configured to transfer heat from hot insulating liquid of the transformer hot-insulating liquid heat transfer system to the CO2 capture module for CO2 desorption; the CO2 capture module hot heat transfer liquid heat transfer system includes a heat exchanger configured to transfer heat from hot insulating liquid of the transformer hot-insulating liquid heat transfer system to the CO2 capture module for CO2 desorption; the CO2 capture module hot heat transfer liquid heat transfer system further includes a hot heat transfer liquid bath coupled to the heat exchanger for transferring additional heat from hot insulating liquid of the transformer hot-insulating liquid heat transfer system to the CO2 capture module for CO2 desorption; the heat exchanger and the CO2 capture module are a combination CO2 capture and transformer insulating liquid heat exchanger system; the heat exchanger is a compact cooler; and/or the combination CO2 capture and transformer insulating liquid heat exchanger system includes one or more louvers to control air flow through the CO2 capture module.

### BRIEF DESCRIPTION OF THE DRAWINGS

The details of the present disclosure, both as to its structure and operation, may be gleaned in part by study of the accompanying drawings, in which like reference numerals refer to like parts, and in which:

FIG. 1A is a perspective view of an embodiment of a CO2 sequester and/or capture cooling system configured to be coupled to a cooling fan of a transformer;

FIG. 1B is a simplified schematic of embodiments of CO2 sequester and/or capture modules of a CO2 sequester and/or capture cooling system;

FIG. 1C is a simplified schematic of embodiments of cooling systems of a transformer;

FIG. 2 is a perspective view of an embodiment of a CO2 sequester and/or capture cooling system configured to be coupled to an air inlet of a cooling fan of a transformer;

FIG. 3A is a perspective view of an embodiment of a CO2 capture cooling system configured to be coupled to an air inlet of a typical compact insulating liquid air cooler of a transformer with the CO2 capture cooling system upstream of the compact cooler and air flowing through the CO2 capture module at ambient temperature;

FIG. 3B is a perspective view of an embodiment of a CO2 sequester and/or capture cooling system configured to be coupled to an air outlet of a cooling fan of a transformer, in particular an air outlet of a typical compact insulating liquid air cooler of a transformer, in particular with the CO2 capture cooling system downstream of the compact cooler and air flowing through the CO2 capture module at a higher temperature (e.g., typically 50-60 degrees C);

FIG. 4A is a perspective view of an embodiment of a CO2 sequester and/or capture cooling system configured to be coupled to an air outlet of a cooling fan of a transformer via an upstream cooling element;

FIG. 4B is a perspective view of another embodiment of a CO2 sequester and/or capture cooling system configured to be coupled to an air outlet of a cooling fan of a transformer via an upstream cooling element;

FIG. 5 is a perspective view of an embodiment of a CO2 sequester and/or capture cooling system configured to be coupled to an air outlet of a cooling fan of a transformer via an upstream cooling element and a simplified schematic of an embodiment of a temperature control system configured to control one or more heater units to heat a CO2 sequester and/or capture module to a desired setpoint temperature, wherein CO2 is flushed from the CO2 sequester and/or capture module;

FIG. 6 is a flow chart of an exemplary method of using CO2 sequester and/or capture cooling system;

FIG. 7 is a perspective view of an embodiment of a CO2 capture cooling system configured to be coupled to a cooling fan of a transformer, and further includes a CO2 capture module hot heat transfer liquid heat transfer system configured to be coupled to a transformer hot-insulating liquid heat transfer system;

FIG. 8 is an additional perspective view of the CO2 capture cooling system of FIG. 7 with the transformer hot-insulating liquid heat transfer system (e.g., radiator-type cooling system) shown in more detail and the CO2 capture module hot heat transfer liquid heat transfer system removed for clarity;

FIG. 9 is another perspective view of the CO2 capture cooling system of FIG. 7 with an embodiment of a CO2 capture module hot heat transfer liquid heat transfer system shown with the high temperature insulating liquid utilized in the desorption process to remove the CO2 from the adsorbent material of the CO2 capture module;

FIG. 10 is further perspective view of the CO2 capture cooling system of FIG. 7 with an additional embodiment of a CO2 capture module hot heat transfer liquid heat transfer system shown with a fan and radiator-type cooling system shown, but in alternative embodiment(s), the fan and radiator-type cooling system is replaced by a fan and compact cooler-type cooling system such as that shown in FIG. 3A or FIG. 3B;

FIG. 11A is perspective view of a combination CO2 capture and transformer insulating liquid compact cooler;

FIG. 11B is an exploded perspective view of the combination CO2 capture and transformer insulating liquid compact cooler of FIG. 11.

### DETAILED DESCRIPTION

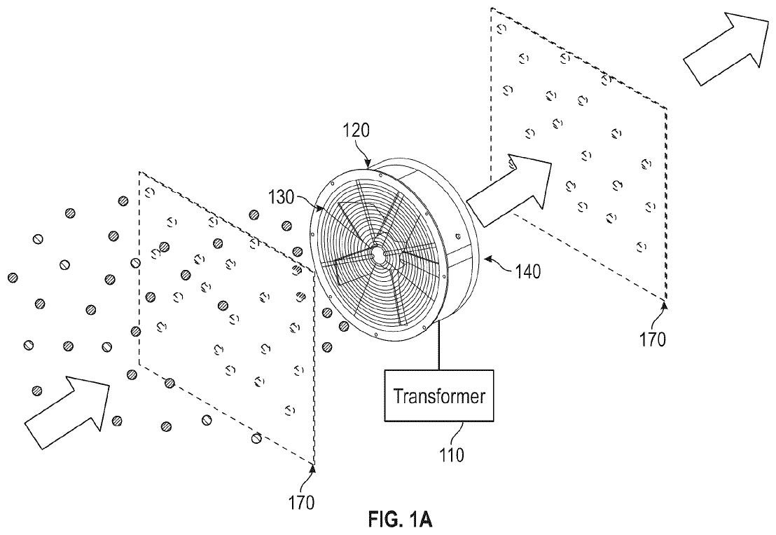

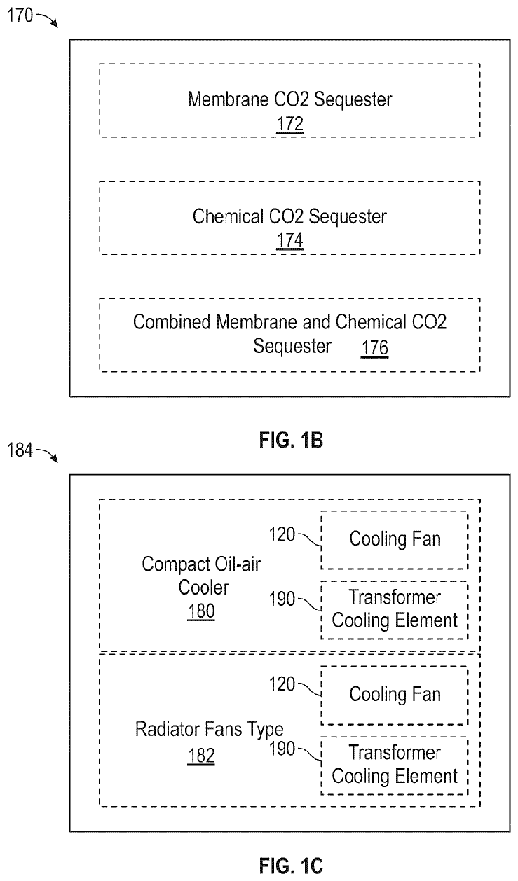

With reference generally to FIGS. 1A-5, embodiments of a CO2 sequester and/or capture cooling system 100 for an electrical transformer (“transformer”) 110 will be described. The transformer 110 includes a cooling fan 120 with an air inlet 130 and an air outlet 140.

In the embodiment shown in FIG. 1A, the CO2 sequester and/or capture cooling system 100 comprises a CO2 sequester and/or capture module 170 configured to be coupled to at least one of the air inlet 130 and the air outlet 140 of the cooling fan 120 of the transformer 110. The CO2 sequester and/or capture module 170 is further configured to separate CO2 from the ambient air that is at least one of received into the air inlet 130 of the cooling fan 120 and exited out of the outlet 140 of the cooling fan 120.

With reference to FIG. 1B, the CO2 sequester and/or capture module 170 is one of a membrane and/or solid material (e.g., granules, pellets) CO2 sequester and/or capture module 172, a chemical CO2 sequester and/or capture module 174, and combined membrane, solid and/or chemical CO2 sequester and/or capture module 176 disposed within the housing 150. Technical advantages of the solid CO2 capture material are easiness of handling, encapsulating and/or reduced air pressure drop due to imperfect stacking. Technical advantages of the chemical CO2 sequester and/or capture module 174 are that it is a single unit or component capable of physically retaining CO2 and allowing CO2 flushing through liquid splashing or similar process, easy to attach to a container, easy to manipulate and replace, and easy to inspect visually for maintenance. Technical advantages of the chemical CO2 sequester and/or capture module 174 also include efficiency in CO2 retention, and ease of circulation in the flushing process. The technical advantage of the combined membrane, solid and/or chemical CO2 sequester and/or capture module 176 compared to the other modules 172, 174 is that it includes a combination of the above-recited technical advantages of the modules 172, 174.

With reference to FIG. 1C, the cooling fan 120 may be part of a compact insulating liquid-air cooler 180, in particular an oil-air cooler 180, or a radiator-fans type 182 of cooling system 184 including transformer cooling element(s) (e.g., radiator(s)) 190 that the ambient air is delivered past, creating transformer-heated ambient air. The transformer-heated ambient air may be used, in part, to raise the temperature of the CO2 sequester and/or capture module 170 to a desired setpoint temperature (e.g., about 100-120 degrees C) for flushing the CO2 from the CO2 sequester and/or capture module 170. Although 100-120 degrees C is provided as an example of the desired setpoint temperature, the desired setpoint temperature may fluctuate with sorbent efficiency. Hot air at the entry point of the capture module 170 may also minimize the impact of moisture that is more prevalent in air than CO2, hence reducing the need to separate captured CO2 from captured moisture. As used herein, hot air is air that is above ambient temperature (e.g., above 15-25 degrees C).

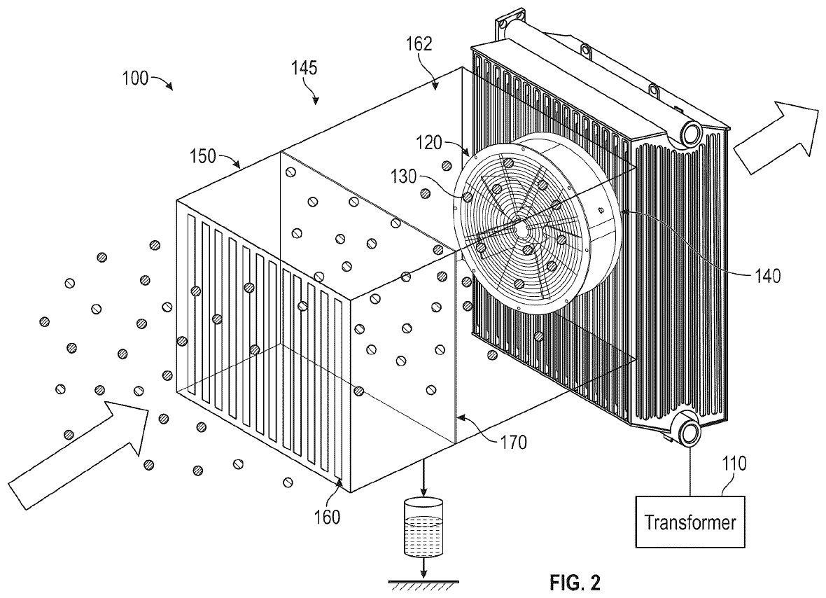

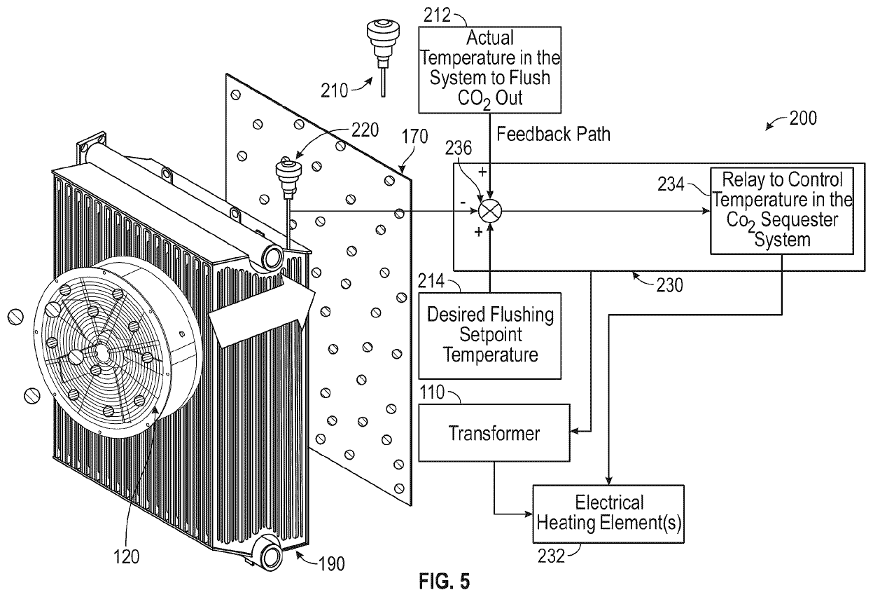

With reference in particular to FIG. 2, an embodiment of the CO2 sequester and/or capture cooling system 100 includes a housing 150 with an air inlet 160 and an air outlet 162 configured to be coupled to the air inlet 130 of the cooling fan 120 of the transformer 110 wherein the ambient air is received in the air inlet 160 of the housing 150 and CO2-reduced air from the CO2 sequester and/or capture module 170 is delivered to the air inlet 130 of the cooling fan 120 via the housing air outlet 162. CO2 is flushed from the CO2 sequester and/or capture module 170 by raising the temperature of the CO2 sequester and/or capture module 170 to the desired flushing setpoint temperature by, for example, but not by way of limitation, the manner described in more detail below with respect to FIG. 5. The flushed CO2 may be fed and/or guided to a CO2 storage/sequester system, as indicated at the bottom of FIG. 2, the CO2 storage/sequester system being schematically indicated by a cylinder in FIG. 2. The flushed CO2 may be, for example, but not by way of limitation, mixed with water and buried in the ground, compressed and/or bottled for commercial use (e.g., chemical industry, carbonated beverages, pharmaceuticals), used for stone forming/growing through carbon mineralization (e.g., CO2-reacting rocks), and used for CO2-optimized greenhouses for growing plants. A technical advantage of this embodiment is that an already operating cooling fan 120 is used to make the air flow through the CO2 sequester and/or capture module 170 and sequester and/or capture the CO2.

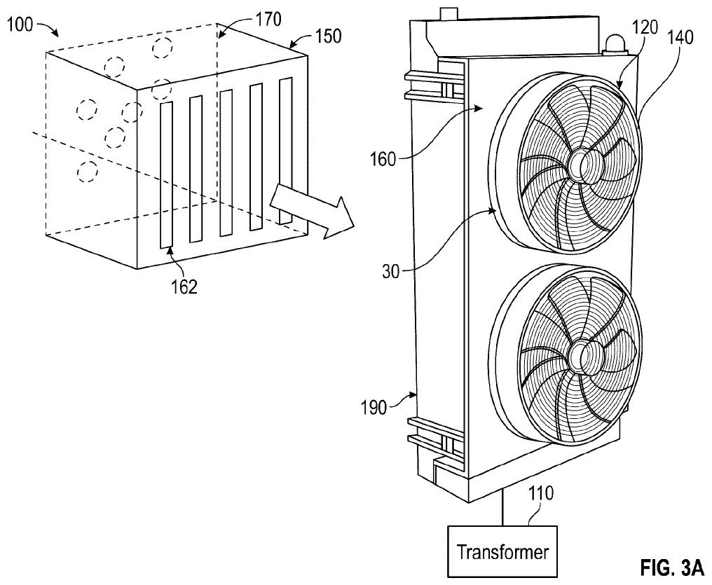

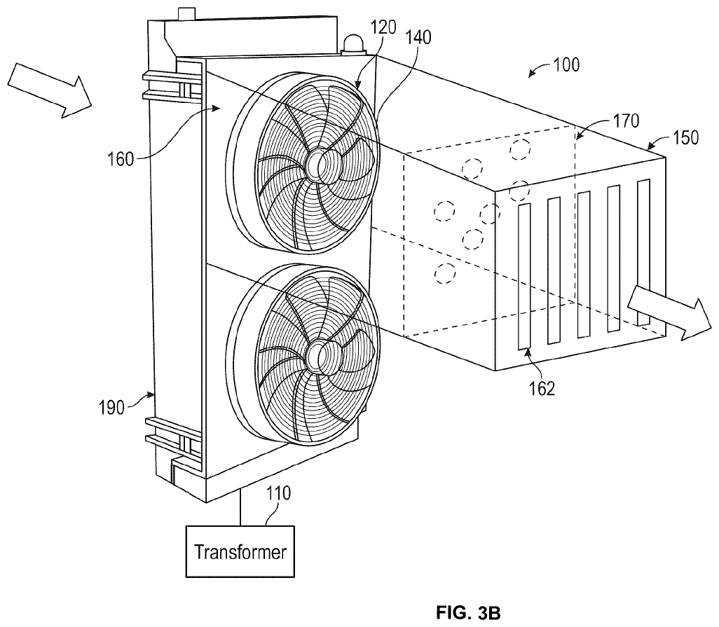

With reference to FIG. 3A and FIG. 3B, additional embodiments of the CO2 sequester and/or capture cooling system 100 will be described.

In FIG. 3A, the housing air outlet 162 is configured to be coupled to the air inlet 130 of the cooling fan 120 so that air flows at ambient temperature through the housing 150 and CO2-reduced air at ambient temperature from the CO2 capture module 170 flows out of the housing air outlet 162. The CO2-reduced air at ambient temperature may be heated by the transformer cooling element 190 of the transformer 110 and exit cooling fan 140 at air outlet 140.

In FIG. 3B, the housing air inlet 160 is configured to be coupled to the air outlet 140 of the cooling fan 120, and wherein the ambient air is delivered from the cooling fan 120 through the air inlet 160 of the housing 150 and CO2-reduced air from the CO2 sequester and/or capture module 170 is delivered from the housing 150 via the housing air outlet 162. In this embodiment, the ambient air delivered from the cooling fan 120 to the CO2 sequester and/or capture module 170 is transformer-heated ambient air that is heated by transformer cooling element 190 of the transformer 110, in particular to typically 50-60 degrees C, and exhausted or sucked by the cooling fan 120 away from the transformer 110. CO2 is optionally first captured from the air and later on, after saturation of the material, is flushed from the CO2 sequester and/or capture module 170 by raising the temperature of the CO2 sequester and/or capture module 170 to the desired flushing setpoint temperature based at least in part on the transformer-heated ambient air and/or more efficiently by raising the temperature of the already hot insulating liquid to the desired setpoint temperature in the manner described in more detail below with respect to FIG. 5, in particular FIGS. 5-11B. A technical advantage of this embodiment is that the ambient air that is delivered from the cooling fan 120 to the CO2 sequester and/or capture module 170 and/or the hot insulating liquid from the entry point of the cooling system is at a significantly higher temperature than ambient temperature, reducing the need for additional energy to raise the temperature of the CO2 sequester and/or capture module 170 to the desired flushing setpoint temperature, in particular the desired CO2 capture and flushing setpoint temperature.

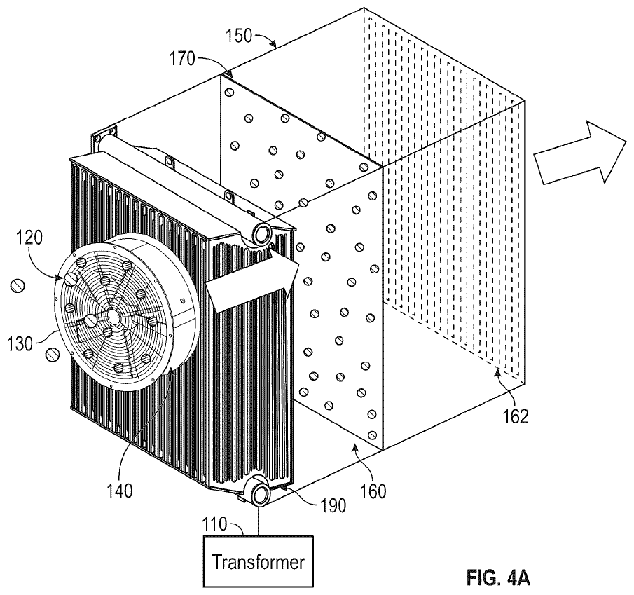

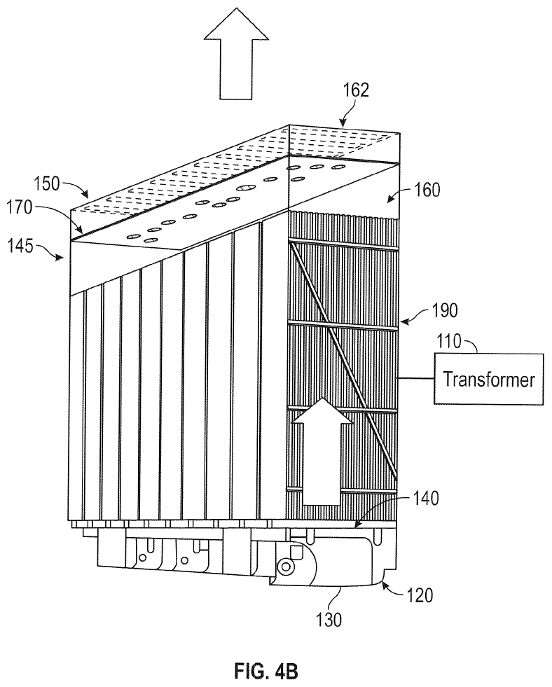

With reference to FIGS. 4A and 4B, further embodiments of the CO2 sequester and/or capture cooling system 100 include the housing air inlet 160 configured to be coupled to the air outlet 140 of the cooling fan 120 via upstream transformer cooling element 190 of the transformer 110, and wherein the ambient air is delivered from the cooling fan 120 past the transformer cooling element 190 and through the air inlet 160 of the housing 150, and CO2-reduced air from the CO2 sequester and/or capture module 170 is delivered from the housing 150 via the housing air outlet 162. CO2 is flushed from the CO2 sequester and/or capture module 170 by raising the temperature of the CO2 sequester and/or capture module 170 to the desired flushing setpoint temperature based at least in part on the transformer-heated ambient air and/or the transformer hot insulating liquid in the manner(s) described in more detail below with respect to FIG. 5, in particular FIGS. 5-11B. In FIG. 4A, the cooling fan(s) 120 may be laterally/horizontally disposed relative to the CO2 sequester and/or capture module 170 and/or the radiator whereas in FIG. 4B, the cooling fan(s) 120 may be vertically disposed (e.g., below) relative to the radiator and the CO2 sequester and/or capture module 170. A technical advantage of this embodiment, particularly of these embodiments, is that the air, in particular the ambient air, that is delivered from the cooling fan 120 to the CO2 sequester and/or capture module 170 is at a significantly higher temperature than ambient temperature, minimizing the effect of moisture capture together with CO2 and/or reducing the need for additional energy to raise the temperature of the CO2 sequester and/or capture module 170 to the desired flushing setpoint temperature.

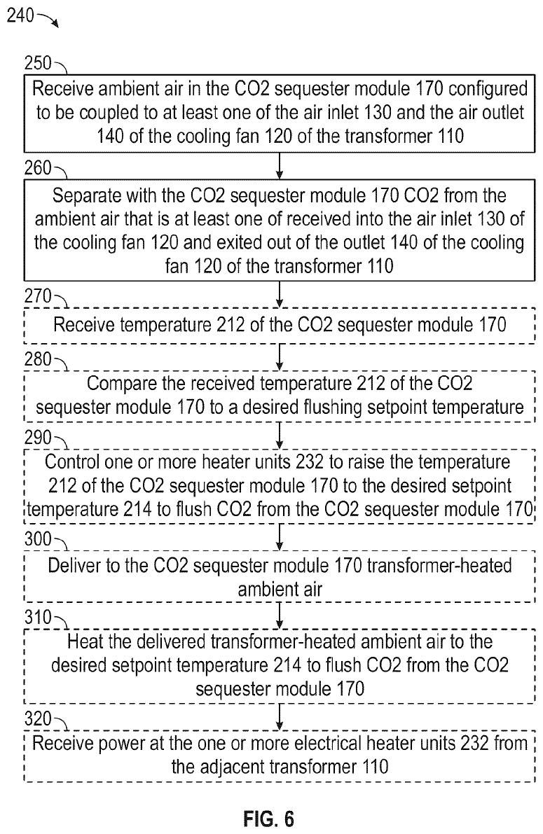

With reference to FIG. 5, the CO2 sequester and/or capture cooling system 100, which may be any of the embodiments of FIGS. 1A-4B, includes a temperature control system 200 configured to control heat the CO2 sequester and/or capture module 170 to the desired setpoint temperature 214, wherein CO2 is flushed from the CO2 sequester and/or capture module 170. The temperature control system 200 shown is a control loop temperature control system 200 comprising a temperature sensor 210 configured to sense actual temperature at the CO2 sequester and/or capture module 170 (Actual Temperature in the System to Flush CO2 Out 212) and/or a cooling element temperature sensor 220 configured to sense a temperature related to a transformer cooling element 190 of the transformer 110 (e.g., a temperature of insulating liquid, in particular of relatively hot insulating liquid). A controller 230 is configured to compare the sensed temperature at the CO2 sequester and/or capture module 170 to the desired flushing setpoint temperature 214 and/or monitor the cooling element temperature sensor 220 to determine if the CO2 sequester and/or capture module 170 requires further heating by one or more heater units 232 (e.g., electrical heater such as resistive heating unit(s), immersion heater(s) and control system, and/or heat tracer(s) and control system) to the desired setpoint temperature 214 to flush CO2 from the CO2 sequester and/or capture module 170. The controller 230 may include one or more electric circuits, one or more processors, and/or one or more electrical elements (e.g., relay 234, comparator 236) to control the one or more heater units 232 to heat the CO2 sequester and/or capture module 170 to the desired flushing setpoint temperature 214. In an example in which the heater units 232 are electrical, electrical power is supplied to the one or more heater units 232 from the adjacent transformer 110. In the embodiments of the CO2 sequester and/or capture cooling system 100 of FIGS. 3A-4B, because the temperature of the CO2 sequester and/or capture module 170 may be raised to the desired flushing setpoint temperature 214 based at least in part on the transformer-heated ambient air and/or on the hot insulating liquid, less heat or power is required to be supplied to the one or more heater units 232 from the transformer 110 to raise the temperature of the CO2 sequester and/or capture module 170 to the desired flushing setpoint temperature 214. A technical advantage of the temperature control system 200 is that it optimizes the method 240 described below, so that the CO2 sequestering and/or capturing and the CO2 flushing process occurs at the desired flushing setpoint temperature 214. With reference to FIG. 6, a method 240 of using CO2 sequester and/or capture cooling system 100 will now be described. In block 250 the CO2 sequester and/or capture module 170 receives ambient air that is at least one of received into the air inlet 130 of the cooling fan 120 and exited out of the outlet 140 of the cooling fan 120 of the transformer 110 (or the compact cooler of FIG. 3A or FIG. 3B). In block 260 the CO2 sequester and/or capture module 170 separates CO2 from the ambient air that is at least one of received into the air inlet 130 of the cooling fan 120 and exited out of the outlet 140 of the cooling fan 120 of the transformer 110 (or compact cooler of FIG. 3A or FIG. 3B). In other embodiments, one or more operations shown in blocks 270-320 may be performed. In block 270 temperature 212 of the CO2 sequester and/or capture module 170 is received by the controller 230. In block 280 the received temperature 212 of the CO2 sequester and/or capture module 170 is compared to the desired flushing setpoint temperature 214 by the controller 230. In block 290 the controller 230 controls the one or more heater units 232 to raise the temperature 212 of the CO2 sequester and/or capture module 170 to the desired setpoint temperature 214 to flush CO2 from the CO2 sequester and/or capture module 170. In block 300 the transformer-heated ambient air and/or hot-insulating/heat transfer liquid(s) is/are delivered to the CO2 sequester and/or capture module 170. In block 310 the delivered transformer-heated ambient air and/or hot-insulating liquid/heat transfer liquid(s) is/are heated to the desired setpoint temperature 214 to flush CO2 from the CO2 sequester and/or capture module 170. In block 320 one or more heater units 232 receive power from the adjacent transformer 110.

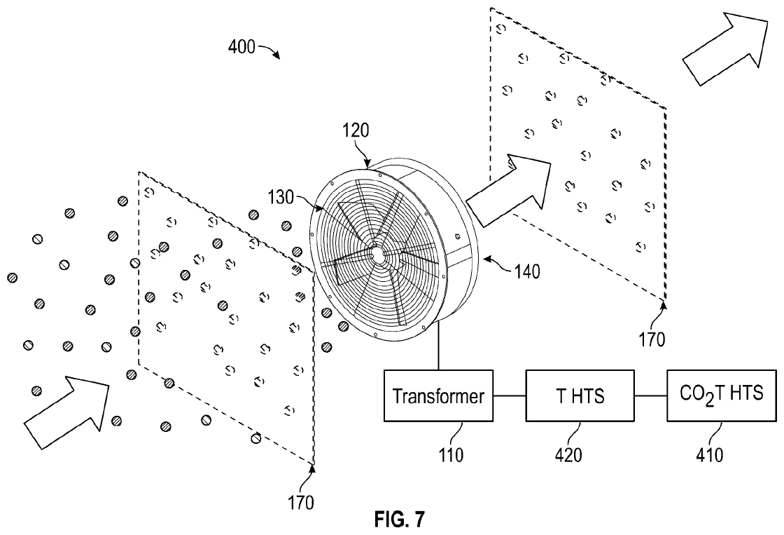

With reference to FIG. 7, another embodiment of a CO2 capture cooling system 400 for a transformer 110 to remove CO2 from air will be described. Similar to the CO2 capture cooling system 100, the CO2 capture cooling system 400 comprises a CO2 capture module 170 configured to be coupled to at least one of the air inlet 130 and the air outlet 140 of the cooling fan 120 of the transformer 110. The CO2 capture module 170 is also configured to be coupled to a CO2 capture module hot heat transfer liquid heat transfer system (“CO2HTS”) 410, which is configured to be coupled to a transformer cooling system or transformer hot-insulating liquid heat transfer system (“T HTS”) 420 of the transformer 110. As used herein, hot-insulating liquid includes mineral oil, natural ester, synthetic ester, silicone fluid, LFH (less flammable hydrocarbons), bio-based hydrocarbons, or other hot-insulating liquids above ambient temperature (e.g., above 15-25 degrees C). The description of the CO2 capture cooling system 100 and temperature control system/method with respect to FIGS. 1A-6 is incorporated herein.

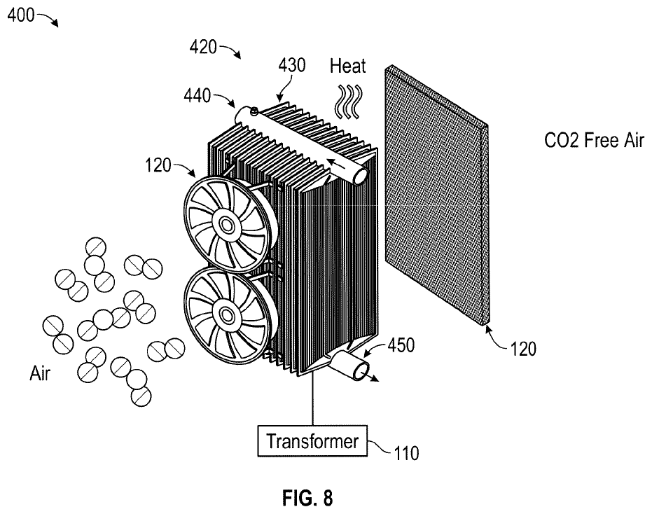

With reference to FIG. 8, the transformer hot-insulating liquid heat transfer system 420 is shown in more detail. The transformer hot-insulating liquid heat transfer system 420 includes a heat exchanger 430, a hot-insulating liquid manifold 440, and a cold-oil outlet 450. Hot insulating liquid that was used to transfer heat away from transformer 110 to cool the transformer 110 enters the heat exchanger 430 at the hot-insulating liquid manifold 440 (e.g., at around 80-90 degrees C (176-194 degrees F)) and exits the heat exchanger 430 at the cold-insulating liquid manifold 450. One or more cooling fans 120 blow air past the heat exchanger 430, cooling the hot insulating liquid passing through the heat exchanger 430, and heating the air, which is delivered to the CO2 capture module 170. As shown in FIG. 7, in alternative embodiments, the CO2 capture module 170 may be coupled to at least one of the air inlet 130 and the air outlet 140 of the cooling fan(s) 120 of the transformer 110 (or compact cooler of FIG. 3A or FIG. 3B).

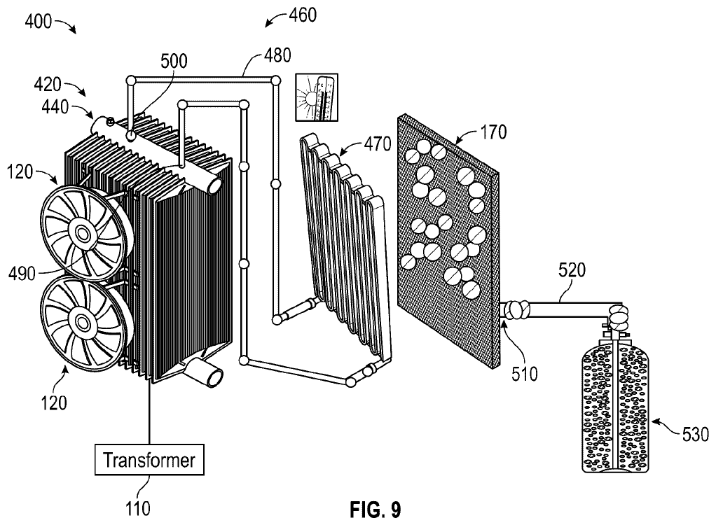

With reference to FIG. 9, an embodiment of a CO2 capture module hot heat transfer liquid heat transfer system 460 is shown in more detail. The CO2 capture module hot heat transfer liquid heat transfer system 460 includes a CO2 capture module heat exchanger 470, and conduits 480 that are coupled to ports 490, 500 of the hot-insulating liquid manifold 440. Wasted energy hot insulating liquid from the hot-insulating liquid manifold 440 (e.g., at about 80-90 degrees C) is transferred to and from the CO2 capture module heat exchanger 470 via the conduits 480. The CO2 capture module hot heat transfer liquid heat transfer system 460 transfers heat from hot insulating liquid of the transformer hot-insulating liquid heat transfer system 420 to the CO2 capture module 170 for CO2 desorption via the CO2 capture module heat exchanger 470, and conduits 480. Wasted energy hot insulating liquid in the hot-insulating liquid manifold 440 may exit the hot-insulating liquid manifold 440 and enter the CO2 capture module hot heat transfer liquid heat transfer system 460 at port 490 and return to the hot-insulating liquid manifold 440 from the CO2 capture module hot heat transfer liquid heat transfer system 460 at port 500. By using the wasted energy hot insulating liquid from the transformer hot-insulating liquid heat transfer system 420 to heat the CO2 capture module 170 to a desired setpoint temperature (e.g., about 100-120 degrees C (212-248 degrees F)) for CO2 capture material desorption, to flush CO2 from the CO2 capture module 170, less energy is required from other energy source(s) to raise the temperature of the CO2 capture module 170 to the desired setpoint temperature to release CO2 for storage for CO2 desorption to flush CO2 from the CO2 capture module 170. The use of wasted heat turns the CO2 capture cooling system 400 into an economically viable investment. While the “typical” energy consumption per ton of CO2 in a conventional system ranges around 1500 kWh/ton, using the CO2 capture cooling system 400 reduces energy consumption per ton of CO2 to 360 kWh/ton (~75% reduction). The CO2 capture module 170 needs to operate near ambient temperature (or temperature much below the desorption temperature (e.g., in the range 100-120 degrees C)) to capture CO2. Flushed CO2 may exit the CO2 capture module 170 at exit 510 and pass through one or more conduits 520 to be stored in container(s) 530 (e.g., for future use) or for other applications.

In alternative embodiments, the CO2 capture module 170 may be coupled to at least one of the air inlet 130 and the air outlet 140 of the cooling fan(s) 120 of the transformer 110.

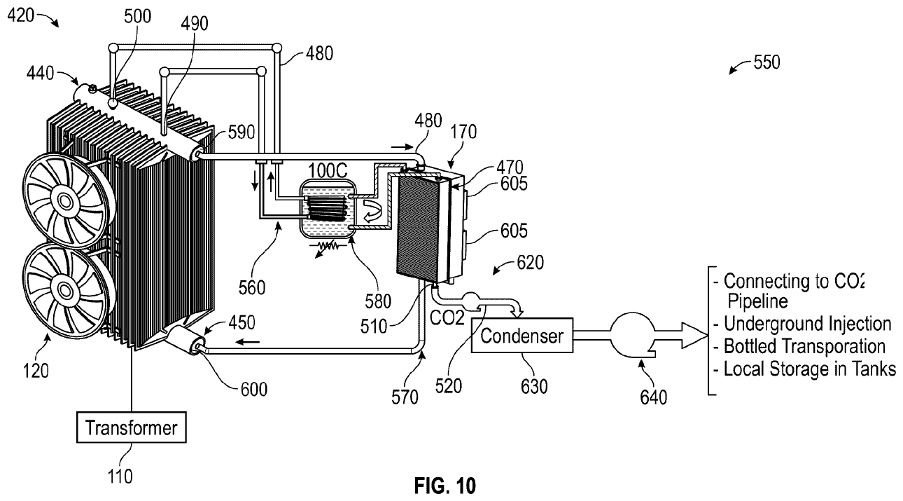

With reference to FIG. 10, an additional embodiment of a CO2 capture module hot heat transfer liquid heat transfer system 550 is shown in more detail. The CO2 capture module hot heat transfer liquid heat transfer system 550 includes a hot heat transfer liquid bath heat transfer circulation system 560 and a CO2 capture module heat exchanger circulation system 570.

The hot heat transfer liquid bath heat transfer circulation system 560 includes a hot heat transfer liquid bath 580 and conduits 480 that are coupled to ports 490, 500 of the hot-insulating liquid manifold 440 and to the CO2 capture module heat exchanger 470.

The CO2 capture module heat exchanger circulation system 570 includes the CO2 capture module heat exchanger 470, and the conduits 480 that are coupled to end port 590 of the hot-insulating liquid manifold 440 and end port 600 of the cold-insulating liquid manifold 450.

Wasted energy hot insulating liquid (e.g., at about 80-90 degrees C) from the hot-insulating liquid manifold 440 is transferred to the CO2 capture module heat exchanger 470, which may be a conventional cooler and include fans 605, and returned to the hot-insulating liquid manifold 440 via the conduit(s) 480. The CO2 capture module hot heat transfer liquid heat transfer system 550 transfers heat from hot insulating liquid of the transformer hot-insulating liquid heat transfer system 420 to the CO2 capture module 170 to the desired setpoint temperature (e.g., about 100-120 degrees C) for CO2 desorption via the CO2 capture module heat exchanger 470, and conduit(s) 480. If additional heat is needed to raise the CO2 capture module 170 to the desired setpoint temperature (e.g., about 100-120 degrees C) to release CO2/for CO2 desorption, hot insulating liquid from the hot heat transfer liquid bath 580 (e.g., at 100-120 degrees C) is transferred to the CO2 capture module heat exchanger 470 via the hot heat transfer liquid bath heat transfer circulation system 560.

Flushed CO2 may be drawn out of the CO2 capture module 170 via a vacuum pump 620, exit the CO2 capture module 170 at exit 510, pass through one or more conduits 520, to a condenser 630 to remove moisture, and delivered via a compressor 640 for a variety of applications (e.g., connecting to CO2 pipeline, underground injection, bottled transportation, local storage in tanks). In alternative embodiments, the CO2 capture module 170 may be coupled to at least one of the air inlet 130 and the air outlet 140 of the cooling fan(s) 120 of the transformer 110.

Although the CO2 capture module hot heat transfer liquid heat transfer system 550 is shown with respect to fans and radiators, in alternative embodiments, the CO2 capture module hot heat transfer liquid heat transfer system 550 is applied to the compact coolers shown in FIG. 3A and/or FIG. 3B.

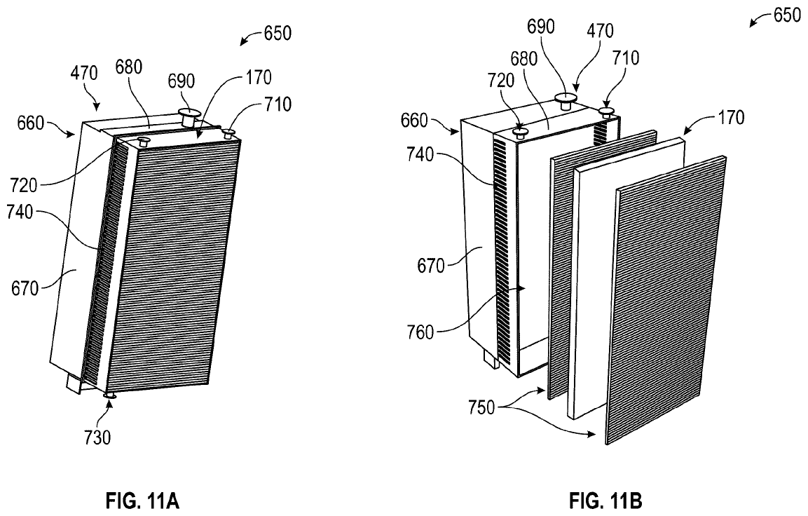

With reference to FIG. 11A and FIG. 11B, an embodiment of a combination CO2 capture and transformer insulating liquid heat exchanger system 650 including the CO2 capture module heat exchanger 470 and the CO2 capture module 170 will be described. The combination CO2 capture and transformer insulating liquid heat exchanger system 650 includes a housing 660 with side walls 670 and end walls 680. The housing 660 houses the CO2 capture module heat exchanger 470, which may be a compact cooler, and includes inlet 690 of the CO2 capture module heat exchanger circulation system 570 along one of the end walls 680, and also includes inlet 710 and outlet 720 of the hot heat transfer liquid bath heat transfer circulation system 560 along one of the end walls 680. The CO2 capture module heat exchanger 470 transfers heat from the transformer insulating liquid (e.g., hot-insulating liquid) to a separated heat transfer liquid, which will, in turn, be circulated through the adsorbent material of the CO2 capture module 170 for the CO2 desorption. A vacuum connection 730 for drawing CO2 out of the CO2 capture module 170 via the vacuum pump 620 is located along an opposite end wall 680. The side walls 670 may include control perforations/air inlets 740 for supplying air to the transformer cooling system to remove heat from the insulating liquid. Inner walls are metallic structures or mechanical blinds flanked by louvers 750 to control the air inlets 740 and seal chamber 760 for vacuum and CO2 extraction/desorption phase. The louvers 750, when closed, allow for a vacuum to be established in the CO2 capture module 170, helping to extract CO2 from the adsorbent material, together with high temperature from the hot heat transfer liquid circulation around the adsorbent material.

A method of using the CO2 capture cooling system 400 and to control heating of the CO2 capture module 170 to the desired setpoint temperature 214 is the same as that described and shown herein with respect to CO2 capture cooling system 100 and FIGS. 5 and 6, which is incorporated by reference herein. The hot heat transfer liquid is circulated in the CO2 capture module hot heat transfer liquid heat transfer system 460, 550 and heat is transferred from the circulated hot heat transfer liquid to the CO2 capture module 170. Because the hot insulating liquid operates in the range of 70-90 degrees C, much less energy is required for the CO2 capture module 170 to reach the example range of 100-120 degrees C for CO2 removal in the desorption process compared to delivering only transformer-heated ambient air to CO2 capture module 170. Circulation of the hot heat transfer liquid in the CO2 capture module hot heat transfer liquid heat transfer system 460, 550 is stopped after CO2 is flushed out of the CO2 capture material and until a next cycle after heating the CO2 capture module 170 to the desired setpoint temperature to flush CO2 from the CO2 capture module 170 and removing CO2 from the CO2 capture module 170. In some applications, the CO2 capture material may need to operate at ambient temperature to remove CO2 from the air (adsorption process) while other materials may need to operate at around 50-60 degrees C during the capture phase. All systems require higher temperature (e.g., 100-120 degrees C) to remove the captured CO2 from the material (desorption process).

The above description of the disclosed embodiments is provided to enable a person skilled in the art to make or use aspects of the present disclosure. Various modifications to these embodiments will be readily apparent to those skilled in the art, and the general principles described herein can be applied to other embodiments without departing from the spirit or scope of the present disclosure. Thus, it is to be understood that the description and drawings presented herein represent embodiment(s) of aspects of the present disclosure and are therefore representative of the subject matter which is broadly contemplated by the present disclosure. It is further understood that the scope of the present disclosure fully encompasses other embodiments that may become obvious to those skilled in the art and that the scope of the present disclosure is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

1. A CO2 sequester and/or capture cooling system comprising:
a CO2 sequester and/or capture module configured to be coupled to at least one of an air inlet and an air outlet of a cooling fan of a transformer, the CO2 sequester and/or capture module further configured to separate CO2 from the ambient air that is at least one of received into the air inlet of the cooling fan and exited out of the outlet of the cooling fan; and
one or more heater units configured to heat the CO2 sequester and/or capture module and a temperature control system configured to control the one or more heater units to heat the CO2 sequester and/or capture module to a desired setpoint temperature wherein CO2 is flushed from the CO2 sequester and/or capture module.

2. The CO2 sequester and/or capture cooling system of claim 1, further comprising:
a housing having a housing air inlet, and a housing air outlet configured to be coupled to the air inlet of the cooling fan, wherein the CO2 sequester and/or capture module is disposed within the housing, and wherein the ambient air is received in the air inlet of the housing and CO2-reduced air from the CO2 sequester and/or capture module is delivered to the air inlet of the cooling fan via the housing air outlet.

3. The CO2 sequester and/or capture cooling system of claim 1, further comprising:
a housing having a housing air inlet configured to be coupled to the air outlet of the cooling fan, and a housing air outlet, wherein the CO2 sequester and/or capture module is disposed within the housing, and wherein the ambient air is delivered from the cooling fan through the air inlet of the housing and CO2-reduced air from the CO2 sequester and/or capture module is delivered from the housing via the housing air outlet.

4. The CO2 sequester and/or capture cooling system of claim 3, wherein the ambient air delivered from the cooling fan to the CO2 sequester and/or capture module is transformer-heated ambient air and wherein the CO2 sequester and/or capture module is configured to be flushed of CO2 based at least in part on the transformer-heated ambient air.

5. The CO2 sequester and/or capture cooling system of claim 3, wherein the cooling fan of the transformer is part of a compact cooler, and the cooling fan is configured to extract air from the compact cooler.

6. The CO2 sequester and/or capture cooling system of claim 3, wherein the housing air inlet is configured to be coupled to the air outlet of the cooling fan via an upstream cooling element, and wherein the ambient air is delivered from the cooling fan past the cooling element and through the air inlet of the housing, and CO2-reduced air from the CO2 sequester and/or capture module is delivered from the housing via the housing air outlet.

7. (canceled)

8. The CO2 sequester and/or capture cooling system of claim 6, further comprising a temperature control system, wherein the temperature control system is a control loop temperature control system.

9. The CO2 sequester and/or capture cooling system of claim 8, wherein the control loop temperature control system includes a temperature sensor configured to sense a temperature at the CO2 sequester and/or capture module.

10. The CO2 sequester and/or capture cooling system of claim 9, wherein the control loop temperature control system includes a controller configured to compare the sensed temperature at the CO2 sequester and/or capture module to the desired setpoint temperature to flush CO2 from the CO2 sequester and/or capture module to determine if the CO2 sequester and/or capture module requires further heating by the one or more heater units to the desired setpoint temperature to flush CO2 from the CO2 sequester and/or capture module.

11. The CO2 sequester and/or capture cooling system of claim 10, wherein the control loop temperature control system includes a cooling element temperature sensor configured to sense a temperature related to a cooling element of the transformer, and the controller is configured to monitor the cooling element temperature sensor to determine if the CO2 sequester and/or capture module requires further heating by the one or more heater units to the desired setpoint temperature to flush CO2 from the CO2 sequester and/or capture module.

12. The CO2 sequester and/or capture cooling system of claim 1, wherein the CO2 sequester and/or capture module is one of a membrane or solid CO2 sequester and/or capture module.

13. The CO2 sequester and/or capture cooling system of claim 1, wherein the CO2 sequester and/or capture module is a chemical CO2 sequester and/or capture module.

14. The CO2 sequester and/or capture cooling system of claim 1, wherein the CO2 sequester and/or capture module is a combined membrane, solid, and/or chemical CO2 sequester and/or capture module.

15. The CO2 sequester and/or capture cooling system of claim 14, further comprising:
a CO2 capture module hot heat transfer liquid heat transfer system configured to be coupled to the transformer hot-insulating liquid heat transfer system, the CO2 capture module hot heat transfer liquid heat transfer system configured to transfer heat from hot insulating liquid of the transformer hot-insulating liquid heat transfer system to the CO2 capture module for CO2 desorption.

16. The CO2 sequester and/or capture cooling system of claim 15, wherein the CO2 capture module hot heat transfer liquid heat transfer system includes a heat exchanger configured to transfer heat from hot insulating liquid of the transformer hot-insulating liquid heat transfer system to the CO2 capture module for CO2 desorption.

17. The CO2 sequester and/or capture cooling system of claim 16, wherein the CO2 capture module hot heat transfer liquid heat transfer system further includes a hot heat transfer liquid bath coupled to the heat exchanger for transferring additional heat from hot insulating liquid of the transformer hot-insulating liquid heat transfer system to the CO2 capture module for CO2 desorption.

18. The CO2 capture cooling system of claim 16, wherein the heat exchanger and the CO2 capture module are a combination CO2 capture and transformer insulating liquid heat exchanger system.

19. The CO2 capture cooling system of claim 16, wherein the heat exchanger is a compact cooler.

20. The CO2 capture cooling system of claim 18, wherein the combination CO2 capture and transformer insulating liquid heat exchanger system includes one or more louvers to control air flow through the CO2 capture module.

21. A method, comprising:
receiving ambient air in a CO2 sequester and/or capture module configured to be coupled to at least one of an air inlet and an air outlet of a cooling fan of a transformer; and
separating with the CO2 sequester and/or capture module CO2 from the ambient air that is at least one of received into the air inlet of the cooling fan and exited out of the outlet of the cooling fan of the transformer;
receiving temperature of the CO2 sequester and/or capture module;
comparing the received temperature of the CO2 sequester and/or capture module to a desired flushing setpoint temperature;
controlling one or more heater units to raise the temperature of the CO2 sequester and/or capture module to the desired setpoint temperature to flush CO2 from the CO2 sequester and/or capture module.

22. (canceled)

23. (canceled)

24. The method of claim 21, wherein the CO2 sequester and/or capture cooling system is adjacent to the transformer, and the method further comprising:
receiving power at the one or more heater units from the adjacent transformer.

25. The method of claim 21, further comprising:
delivering to the CO2 capture module heat from wasted energy hot insulating liquid of a transformer hot-insulating liquid heat transfer system.

26. The CO2 sequester and/or capture cooling system of claim 1, wherein the CO2 sequester and/or capture module is configured to be coupled to a hot-insulating liquid heat transfer system of the transformer.
